(19) United States
(12) Patent Application Publication
(10) Pub. No.: US 2025/0226375 A1
(43) Pub. Date: Jul. 10, 2025

(54) METHOD OF CONTROLLING BINDER CRYSTALLIZATION DURING DRYING PROCESS IN ELECTRODE MANUFACTURING

(71) Applicant: Ford Global Technologies, LLC, Dearborn, MI (US)

(72) Inventors: Maryamossadat Akram, Ann Arbor, MI (US); Wanjiao Liu, Ann Arbor, MI (US); Avinesh Ojha, Southgate, MI (US)

(73) Assignee: Ford Global Technologies, LLC, Dearborn, MI (US)

(21) Appl. No.: 18/407,068

(22) Filed: Jan. 8, 2024

(51) Int. Cl. H01M 4/04; H01M 4/62

(52) U.S. Cl. CPC H01M 4/04; H01M 4/623

(57) ABSTRACT

A method of producing an electrode for use in battery manufacturing includes drying an electrode material in a compact phase, applying an electric field to the electrode material during the compact phase, and adjusting a frequency and a magnitude of the electric field to control crystallization of a binder material. The electrode material comprises a binder material. The rate of crystallization of the binder material is increased or decreased.

### FIELD

The present disclosure relates to battery manufacturing and specifically to drying an electrode for use in such battery.

### BACKGROUND

The statements in this section merely provide background information related to the present disclosure and may not constitute prior art.

A typical process for battery electrode manufacturing consists of mixing a slurry of an electrode material, coating the electrode material onto a surface of a current collector, drying the electrode material, and calendaring (compressing) the dried electrode material. Each step of the electrode manufacturing process influences the subsequent manufacturing steps and the overall performance of the battery.

Referring to FIG. 1, a typical drying process for manufacturing a battery electrode is shown which includes multiple drying phases. Prior to drying, a slurry of an electrode material 100 containing electrode particles 110, a binder material 120 having binder particles, and solvent 130 is applied to a current collector 140, in a pre-drying phase (a). At the beginning of drying, in a shrinkage phase (b), the evaporation rate of the solvent 130 is higher and the drying process is more rapid. In this phase, solvent 130 easily moves to a top surface of the electrode material 100 where evaporation occurs. As the solvent 130 moves, some of the particles of the binder material 120 are transported with the solvent 130. Due to solvent 130 removal, the electrode material 100 shrinks and begins to consolidate.

Following the shrinkage phase (b), the thickness of the electrode material 100 remains constant with solvent 130 and binder material 120 remaining in the network of the porous microstructure, in a capillary phase (c) and a compact phase (d). In the ‘capillary phase’, the binder material 120 and the electrode particles 110 are beginning to connect into a network of pores. The net convection of solvent 130 is still upward through capillary action, taking more binder particles 120 toward the top surface of the electrode material 100. However, the slower effect allows diffusion to migrate some binder material 120 into a more equalized distribution.

In the compact phase (d), the porous microstructure of the electrode material 100 dries and solidifies, and isolated solvent 130 regions are formed. In the localized evaporating regions, binder material 120 begin to crystallize and lose mobility. In some cases, solvent 130 may be trapped in the isolated pores by the crystallized binder material 120, requiring a more extended drying process.

Finally, in the dried electrode (e), the solvent 130 has been evaporated completely and the electrode particles 110 are bound together by the binder material 120 to form a porous nanostructure.

These challenges related to controlling binder crystallization in an electrode material for battery manufacturing are addressed by the present disclosure.

### SUMMARY

This section provides a general summary of the disclosure and is not a comprehensive disclosure of its full scope or all of its features.

In one form, the present disclosure provides a method of producing an electrode for use in battery manufacturing. The method includes drying an electrode material in a compact phase, applying an electric field to the electrode material during the compact phase; and adjusting a frequency and a magnitude of the electric field to control crystallization of a binder material. The electrode material comprises a binder material.

In variations of this method, which may be implemented individually or in any combination: the binder material is polyvinylidene fluoride; the crystallized binder material forms a nanoporous structure; the drying process is performed at a temperature of 70° C. to 120° C.; the frequency has a range of 0.01 Hz to 10 KHz; the magnitude has a range of 0.1-200 kV/cm; and the electric field is applied for the entire compact phase of drying

The present disclosure further provides a method of producing an electrode for use in battery manufacturing. The method includes drying an electrode material in a compact phase, applying an electric field to the electrode material during the compact phase; and adjusting a frequency and a magnitude of the electric field to decrease a rate of crystallization of a binder material. The electrode material comprises a binder material.

In variations of this method, which may be implemented individually or in any combination: the binder material is polyvinylidene fluoride; the drying process is performed at a temperature of 70° C. to 120° C.; the frequency has a range of 0.01 Hz to 10 kHz; the magnitude has a range of 0.1-200 kV/cm; and the crystallized binder material forms a nanoporous structure.

In yet another form, the present disclosure provides another method of producing an electrode for use in battery manufacturing. The method includes drying an electrode material in a compact phase, applying an electric field to the electrode material during the compact phase; and adjusting a frequency and a magnitude of the electric field to increase a rate of crystallization of a binder material. The electrode material comprises a binder material.

In variations of this method, which may be implemented individually or in any combination: the binder material is polyvinylidene fluoride; the crystallized binder material forms a nanoporous structure; the drying process is performed at a temperature of 70° C. to 120° C.; the frequency has a range of 0.01 Hz to 10 KHz; the magnitude has a range of 0.1-200 kV/cm; and the electric field is applied for the entire compact phase of drying.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating phases of a battery electrode drying process according to the prior art;

FIG. 2 is a graph illustrating isothermal crystallization in the presence of an electric field with different frequencies, according to the teachings of the present disclosure;

FIG. 3 is a graph illustrating isothermal crystallization in the presence of an electric field with different magnitudes, according to the teachings of the present disclosure; and

FIG. 4 is a flow diagram illustrating a novel method of producing a producing a battery electrode, according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

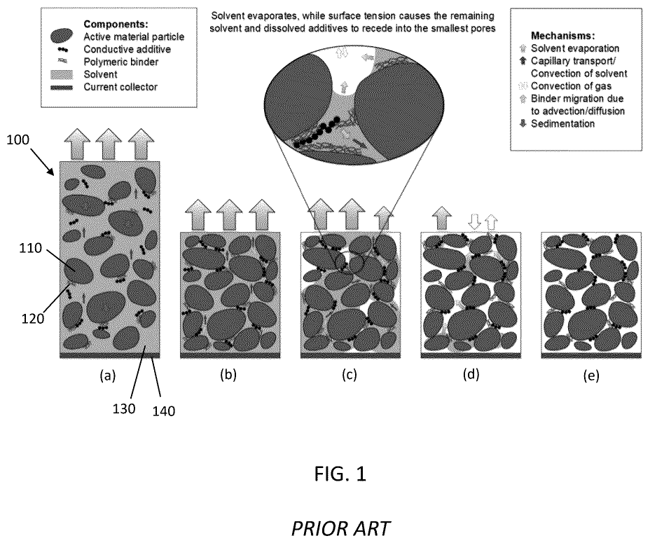

The present disclosure provides an innovative method to control the distribution of binder material during the drying process for a battery electrode, in general, by applying an electric field to the electrode material during the compact phase and adjusting a frequency and a magnitude of the electric field to control crystallization of the binder material. In order to control the distribution of the binder material and the porous nanostructure that develops as the electrode material dries and the binder material crystalizes, an electric field is applied to the electrode material during the compact phase of drying (see FIG. 1). Adjusting the frequency and magnitude of the electric field controls the rate of crystallization of the binder material and the crystallized phase that forms, as set forth in greater detail below.

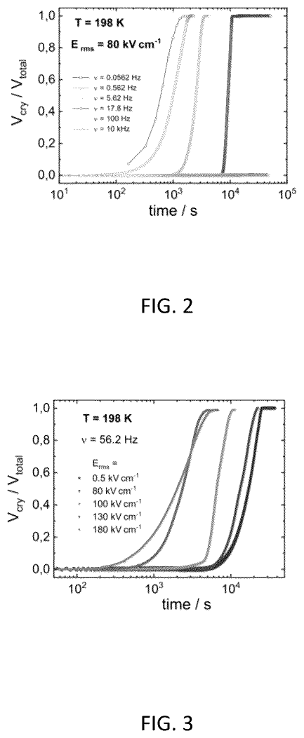

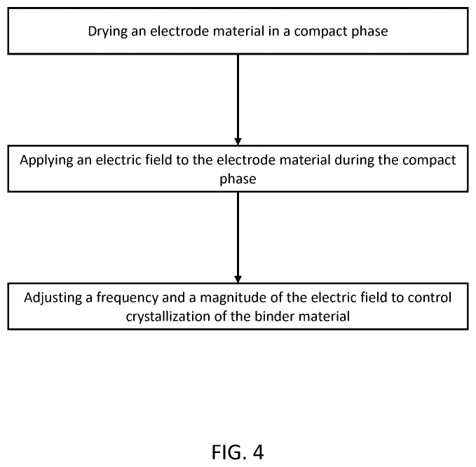

Referring to FIG. 2, crystallization over time of a typical binder material (e.g., vinyl ethylene carbonate) is shown for several frequencies at a voltage magnitude of 80 kV/cm, and at a temperature of 198 Kelvin. The effect of the frequency of an AC (alternating current) electric field with a magnitude of 80 kV/cm on the crystallization rate is depicted as the ratio of the crystallized volume of the binder to the total volume of the binder (V_{cry}/Vₜₒₜₐₗ) versus log t curves in seconds. At a frequency of 100 Hz or higher, no significant crystallization is observed for times up to 50000 seconds (˜14 hours). However, at a lower frequency of 18 Hz, crystallization is substantially completed after 10,000 seconds, and at 56 Hz, the crystallization rate has increased by another factor of 10. As such, the rate of crystallization can be increased by increasing the frequency of the electric field. In one form of the present disclosure, the electric field has a frequency between 0.01 Hz and 10 KHz. It should be understood, however, that other frequencies, and frequency ranges, may be employed as a function of the specific electrode materials. Further, it should also be understood that frequencies between the ranges set forth herein, are within the scope of the present disclosure. For example, within the frequency range of 0.01 Hz and 10 KHz, frequencies of 100 Hz, 120 Hz, 200 Hz, and so on are within the scope of the teachings herein.

Referring to FIG. 3, crystallization over time of vinyl ethylene carbonate at a fixed frequency of 56.2 Hz is shown for different voltage magnitudes and at a temperature of 198 Kelvin. Thus, the rate of crystallization can additionally or alternatively be increased by increasing the magnitude of the electric field. Preliminary testing has shown that the crystallization rate at a fixed frequency of 56 Hz can be increased by increasing the electric field magnitude. In one form, the electric field has a magnitude between 0.1 and 200 kV/cm. It should be understood, however, that other frequencies, and frequency ranges, may be employed as a function of the specific electrode materials. Further, it should also be understood that frequencies between the ranges set forth herein, are within the scope of the present disclosure. For example, within the magnitude range of 0.1 to 200 kV/cm, magnitudes of 10 kV/cm, 50 kV/cm, 100 kV/cm, 120 kV/cm, 150 kV/cm, and so on are within the scope of the teachings herein.

By adjusting the frequency and/or magnitude of the electric field to change the rate of crystallization, the point in which the binder material becomes immobile can be decreased or increased. In the case of delaying crystallization, the binder material may continue to diffuse through the electrode material. On the other hand, the rate of crystallization can be increased to prevent further movement of binder material 120 into isolated pores. Moreover, the precise phase of the crystal that forms can be optimized.

Referring to FIG. 5, a method of producing a producing a battery electrode is illustrated. To begin, a slurry of an electrode material is applied to a surface of a current collector. The electrode material is in the form of a homogenous slurry and applied as a single monolithic layer. The electrode material generally includes electrode particles, a binder material, and a solvent, but is not necessarily limited thereto.

The electrode particles include active particles and may optionally include electrically conductive additive particles. The active particles form the bulk of the electrode and interact with ions in the battery fluid, such as lithium ions in a lithium battery. In one form of the present disclosure, the active particles are a carbon material such as graphite. In other forms, the active particles are lithium titanate (Li4Ti5O12), lithium nickel manganese cobalt oxide, and graphene, among others. The conductive additive particles aid the conductivity of the electrode and the movement of ions to the active particles. In one form, the conductive additive particles include carbon black. It should be understood that other materials for the electrode particles, which have the described properties and functions set forth herein, may be implemented while remaining within the scope of the present disclosure.

The binder material may be any of a variety of polymeric materials that function to hold the electrode particles together. For example, the binder material may be fluoro-acrylic polymer, polytetrafluoroethylene (PTFE), polyvinylidene fluoride, polyacrylates, aliphatic polymers, aromatic polymers, oligo- and poly-saccharides, chitosan, alginate, pectin, amylose, starch, gums, lignin, and proteins, among others. It should be understood that other materials which serve to bind the electrode particles may be utilized while remaining within the scope of the present disclosure.

The solvent generally functions to suspend or disperse the electrode particles and the binder material and may be any of a variety of materials, including by way of example, H2O (Water), N-Methyl-2-pyrrolidone (NMP), Dimethylformamide (DMF), Dimethylacetamide (DMAC), and Dimethyl sulfoxide (DMSO), among others. It should be understood that other solvents may be implemented while remaining within the scope of the present disclosure.

After application to the current collector, the electrode material is dried to remove the solvent, leaving the binder material and the electrode particles, which form a porous nanostructure. The drying process is discussed in more detail above. In one form, the electrode material is dried at a temperature of 70°-120° C.

As discussed above, an electrode field is applied to the electrode material 100 during the compact phase of the drying process. Adjusting the frequency and magnitude of the electric field controls the rate of crystallization of the binder material. In one form, the electric field has a frequency between 0.01 Hz and 10 KHz. In one form, the electric field has a magnitude between 0.1 and 200 kV/cm. In one form, the electrode field is applied throughout the entire compact phase.

It should be understood that the magnitude and frequency of the electric field will vary as a function of the electrode materials (in particular the binder material), the volume of electrode materials, the stage of drying where the electric field is applied, temperature, the solvent selection, the material properties of active materials and conductive additives.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of producing an electrode for use in battery manufacturing, the method comprising:
drying an electrode material in a compact phase, the electrode material comprising a binder material;
applying an electric field to the electrode material during the compact phase; and
adjusting a frequency and a magnitude of the electric field to control crystallization of the binder material.

2. The method of claim 1, wherein the binder material is polyvinylidene fluoride.

3. The method of claim 1, wherein the crystallized binder material forms a nanoporous structure.

4. The method of claim 1, wherein the drying is performed at a temperature of 70° to 120° C.

5. The method of claim 1, wherein the frequency has a range of 0.01 Hz to 10 kHz.

6. The method of claim 1, wherein the magnitude has a range of 0.1-200 kV/cm.

7. The method of claim 1, wherein the electric field is applied for the entire compact phase of drying.

8. A method of producing an electrode for use in battery manufacturing, the method comprising:
drying an electrode material in a compact phase, the electrode material comprising a binder material;
applying an electric field to the electrode material during the compact phase; and
adjusting a frequency and a magnitude of the electric field to decrease a rate of crystallization of the binder material.

9. The method of claim 8, wherein the binder material is polyvinylidene fluoride.

10. The method of claim 8, wherein the drying is performed at a temperature of 70° to 120° C.

11. The method of claim 8, wherein the frequency has a range of 0.01 Hz to 10 kHz.

12. The method of claim 8, wherein the magnitude has a range of 0.1-200 kV/cm.

13. The method of claim 8, wherein the crystallized binder material forms a nanoporous structure.

14. A method of producing an electrode for use in battery manufacturing, the method comprising:
drying an electrode material in a compact drying phase, the electrode material comprising a binder material;
applying an electric field to the electrode material during the compact phase; and
adjusting a frequency and a magnitude of the electric field to increase a rate of crystallization of a binder material.

15. The method of claim 14, wherein the binder material is polyvinylidene fluoride.

16. The method of claim 14, wherein the crystallized binder material forms a nanoporous structure.

17. The method of claim 14, wherein the drying is performed at a temperature of 70° to 120° C.

18. The method of claim 14, wherein the frequency has a range of 0.01 Hz to 10 KHz.

19. The method of claim 14, wherein the magnitude has a range of 0.1-200 kV/cm.

20. The method of claim 14, wherein the electric field is applied for the entire compact phase of drying
